(19) United States
(12) Patent Application Publication
(10) Pub. No.: US 2025/0357603 A1
(43) Pub. Date: Nov. 20, 2025

(54) TRACTION BATTERY PACK CELL STACK COMPRESSIBLE DIVIDER ASSEMBLY

(71) Applicant: Ford Global Technologies, LLC, Dearborn, MI (US)

(72) Inventors: Bhaskara Rao Boddakayala, Troy, MI (US); Patrick Roxin, Livonia, MI (US); John Marshall Penney, Livonia, MI (US); Eid Farha, Ypsilanti, MI (US)

(21) Appl. No.: 18/665,974

(22) Filed: May 16, 2024

(51) Int. Cl. H01M 50/249; H01M 50/289; H01M 50/483

(52) U.S. Cl. CPC H01M 50/249; H01M 50/289; H01M 50/483

(57) ABSTRACT

A traction battery pack assembly includes a cell stack within an interior of an enclosure. The cell stack including a plurality of battery cells and a divider assembly disposed along a cell stack axis. The divider assembly is arranged between a first battery cell and a second battery cell of the plurality of battery cells. The divider assembly includes a compressible pad that includes a housing disposed about a foam.

### TECHNICAL FIELD

This disclosure details exemplary dividers for a traction battery and, more particularly, dividers that are compressible.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines.

### SUMMARY

In some aspects, the techniques described herein relate to a traction battery pack assembly, including: a cell stack within an interior of an enclosure, the cell stack including a plurality of battery cells and a divider assembly disposed along a cell stack axis, the divider assembly arranged between a first battery cell and a second battery cell of the plurality of battery cells, the divider assembly including a compressible pad that includes a housing disposed about a foam.

In some aspects, the techniques described herein relate to a traction battery pack assembly, wherein the foam is a ceramic foam.

In some aspects, the techniques described herein relate to a traction battery pack assembly, wherein the housing is a spray transfer molded housing.

In some aspects, the techniques described herein relate to a traction battery pack assembly, wherein the divider assembly further includes a frame having a T-shaped cross-sectional profile.

In some aspects, the techniques described herein relate to a traction battery pack assembly, wherein the frame is a pultruded frame.

In some aspects, the techniques described herein relate to a traction battery pack assembly, wherein the frame is an extruded frame.

In some aspects, the techniques described herein relate to a traction battery pack assembly, wherein the divider assembly includes a polymer-based frame having a column portion sandwiched between the first battery cell and the second battery cell, and a platform portion disposed outside the plurality of battery cells relative to the cell stack axis, the compressible pad a first compressible pad on a first side of the column portion, the divider assembly further including a second compressible pad on an opposite, second side of the column portion.

In some aspects, the techniques described herein relate to a traction battery pack assembly, wherein the platform portion is configured to interface with an enclosure cover or an intermediate structure.

In some aspects, the techniques described herein relate to a traction battery pack assembly, wherein the first compressible pad and the second compressible pad are secured to the column portion with an adhesive tape.

In some aspects, the techniques described herein relate to a traction battery pack assembly, wherein the compressible pad further includes mica layers sandwiching the foam within the housing.

In some aspects, the techniques described herein relate to a traction battery pack assembly, wherein the compressible pad further includes an aerogel layer within the housing.

In some aspects, the techniques described herein relate to a traction battery pack assembly, wherein the compressible pad further includes a mesh layer within the housing.

In some aspects, the techniques described herein relate to a traction battery pack assembly, wherein the compressible pad further includes a basalt layer within the housing.

In some aspects, the techniques described herein relate to a traction battery pack assembly, wherein the compressible pad further includes a densified, non-woven ceramic layer within the housing.

In some aspects, the techniques described herein relate to a traction battery pack assembly, wherein the divider assembly includes a polymer-based frame having a column portion sandwiched between the first battery cell and the second battery cell, and a platform portion disposed outside the plurality of battery cells relative to the cell stack axis, the compressible pad a first compressible pad on a first side of the column portion, the divider assembly further including a second compressible pad on an opposite, second side of the column portion, wherein the column portion includes a metal or metal alloy layer.

In some aspects, the techniques described herein relate to a traction battery pack assembly, wherein the metal or metal alloy layer is stainless steel.

In some aspects, the techniques described herein relate to a traction battery pack assembly, wherein the divider assembly includes a T-shaped frame having a column portion sandwiched between the first battery cell and the second battery cell, and a platform portion disposed outside the plurality of battery cells relative to the cell stack axis, the compressible pad a first compressible pad on a first side of the column portion, the divider assembly further including a second compressible pad on an opposite, second side of the column portion.

In some aspects, the techniques described herein relate to a traction battery pack assembly, wherein the column portion includes a column housing disposed about a multi-layered column structure, wherein the platform portion includes a platform housing disposed about a multi-layered platform structure.

In some aspects, the techniques described herein relate to a traction battery pack assembly, wherein the multi-layered column structure includes at least one aramid honeycomb layer, at least one aerogel layer, at least one metallic mesh layer, and at least one mica layer.

In some aspects, the techniques described herein relate to a traction battery pack assembly, wherein the multi-layered platform structure includes at least one aramid honeycomb layer sandwiched between a pair of metallic layers.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of the battery pack of FIG. 1.

FIG. 3 shows a section view taken at line 3-3 in FIG. 2 showing a cell stack of the battery pack within an enclosure of the battery pack.

FIG. 4 illustrates a highly schematic view of a divider assembly from the cell stack of FIG. 3 according to an exemplary embodiment of the present disclosure.

FIG. 5 shows a highly schematic view of a divider assembly for use in the cell stack of FIG. 3 according to yet another exemplary embodiment.

FIG. 6 shows a highly schematic view of a divider assembly for use in the cell stack of FIG. 3 according to yet another exemplary embodiment.

FIG. 7 shows a highly schematic view of a divider assembly for use in the cell stack of FIG. 3 according to yet another exemplary embodiment.

FIG. 8 shows a highly schematic view of a divider assembly for use in the cell stack of FIG. 3 according to yet another exemplary embodiment.

FIG. 9 shows a highly schematic view of a divider assembly for use in the cell stack of FIG. 3 according to yet another exemplary embodiment.

### DETAILED DESCRIPTION

A battery pack of an electrified vehicle can include at least one cell stack having battery cells and divider assemblies distributed along a cell stack axis. The divider assemblies can be compressible to accommodate expansion of the battery cells. This disclosure is directed toward exemplary divider assemblies.

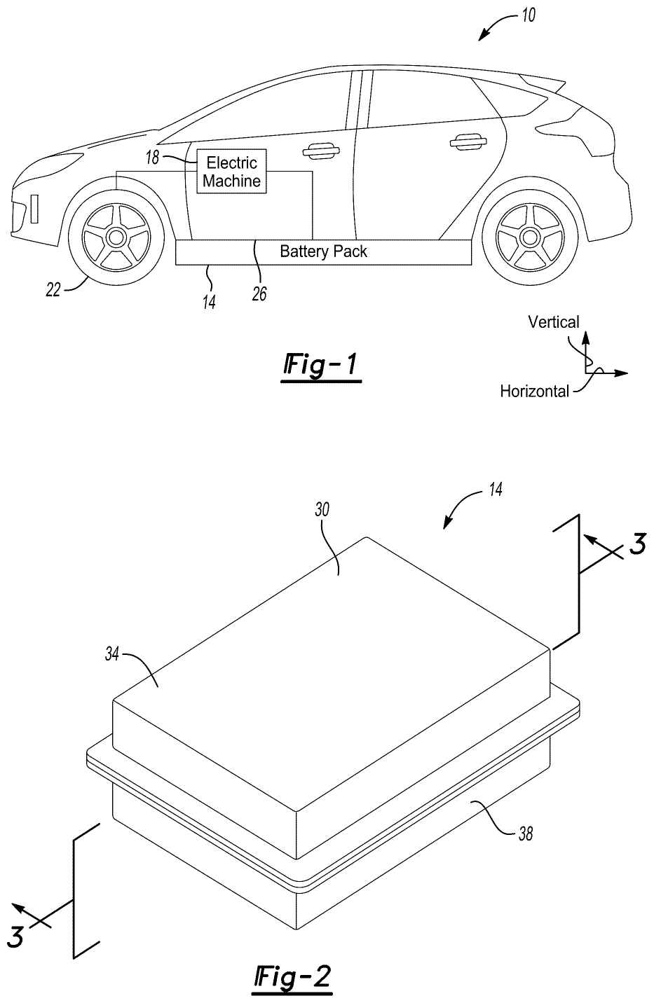

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

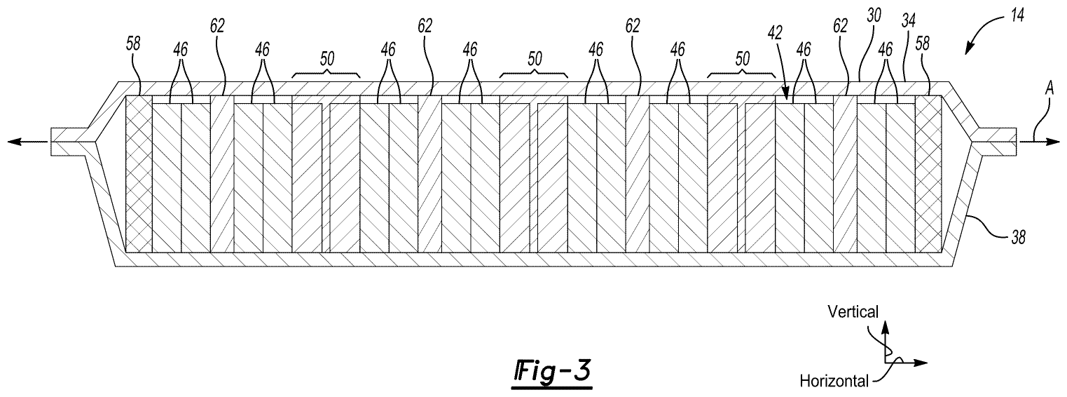

Referring now to FIGS. 2 to 4, the traction battery pack 14 includes an enclosure assembly 30. that includes an enclosure cover 34 and an enclosure tray 38. The enclosure cover 34, in this example, is vertically above the enclosure tray 38. In other examples, however, the enclosure cover 34 could be arranged below, or to a side of the enclosure tray 38.

Vertical and horizontal, for purposes of this disclosure, are with reference to ground and a general orientation of the traction battery pack 14 during operation. Various terms such as “above,” “below,” “top,” and “bottom” are used relative to the arrangement of the components of the traction battery pack 14 in the various drawings and should not otherwise be deemed limiting. These terms are with reference to the general orientation of the traction battery pack 14 when installed within the electrified vehicle 10 of FIG. 1.

The enclosure cover 34 is welded to the enclosure tray 38 in one example of this disclosure. While welding is mentioned, the enclosure cover 34 and enclosure tray 38 could be connected using other connection techniques, such as adhesive. Further, while an exemplary enclosure assembly 30 is shown in the drawings, the enclosure assembly 30 may vary in size, shape, and configuration within the scope of this disclosure.

The traction battery pack 14 includes at least one cell stack 42 housed within an interior of the enclosure assembly 30. The example cell stack 42 includes a plurality of individual battery cells 46 disposed along a cell stack axis A. The cell stack 42 could include any number of battery cells 46. The traction battery pack 14 could employ any number of cell stacks 42 within the enclosure assembly 30. Thus, this disclosure is not limited to the exact configuration shown in FIG. 2. Further, while the battery cells 46 of FIG. 2 are positioned side-by-side relative to one another, other configurations are also contemplated within the scope of this disclosure, including but not limited to embodiments in which the battery cells 46 are stacked on top of one another, for example.

In an embodiment, the battery cells 46 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The cell stack 42 further includes a plurality of divider assemblies 50, a pair of endplates 58, and a plurality of spacer assemblies 62 disposed along the cell stack axis A. The battery cells 46, the divider assemblies 50 and the spacer assemblies 62 are sandwiched along the axis A between the endplates 58.

The spacer assemblies 62 are, in this example, blocks of ceramic foam wrapped in a polyethylene terephthalate film. The endplates 58 can be a metal or metal alloy.

The divider assemblies 50 are disposed along the cell stack axis A between groups of the battery cells 46. Each divider assembly 50 includes, in this example, a frame 70, a first compressible pad 74, and a second compressible pad 78.

The frame 70 is a polymer-based structure having a column portion 82 and a platform portion 84. The column portion 82 extends longitudinally in a vertical direction. The platform portion 84 is disposed outside the battery cells 46 and, more specifically, above the battery cells 46. The platform portion 84 extends longitudinally in a horizontal direction and over vertical tops of the first compressible pad 74 and the second compressible pad 78. The frame 70 has a T-shaped cross-sectional profile.

The frame 70 can be a pultruded frame. In another example, the frame 70 can be an extruded frame. A person having skill in this art and the benefit of this disclosure would be able to structurally distinguish a pultruded frame or an extruded frame from another type of frame. Thus, the frame 70 being pultruded or extruded implicates structure to the frame 70. The frame 70 extends from the enclosure tray 38 to the underside of the enclosure cover 34. The frame 70 can be a polymer-based material that is reinforced with a reinforcement material, such as glass, a metallic honeycomb, or some other reinforcement. The reinforcement material can provide air pockets within the frame 70. In some examples, the column portion 82 can include the reinforcement material, and the platform portion 84 may omit the reinforcement material.

The platform portion 84 interfaces with an underside of the enclosure cover 34. The frame 70 helps to support the enclosure cover 34 and the loads associated therewith. In another example battery pack having multiple tiers of cell stacks 42, the frame 70 of a divider assembly 50 within a lower tier cell stack can help to support an upper tier cell stack through an intermediate structure, such as a support plate.

The first compressible pad 74 is secured to a first axial side of the column portion 82 of the frame 70. The second compressible pad 78 is secured to an opposite axially facing side of the column portion 82 of the frame 70. In this example, adhesive tape 86 is used to secure the first compressible pad 74 to a first axially facing side of the column portion 82, and to secure the second compressible pad 78 to the second axially facing side of the column portion 82. Adhesive tape 86 can also be used to secure the first compressible pad 74 and the second compressible pad 78 to an axially adjacent battery cell 46 of the cell stack 42. The adhesive tape 86 can be a pressure-sensitive adhesive tape. In other examples a spray adhesive or another type of adhesive is used instead of the adhesive tape 86.

The first compressible pad 74 includes a mica layer 90, a foam layer 92, at least one piece of adhesive tape 94, another mica layer 96, and an aerogel layer 98. The first compressible pad 74 further includes a housing 100 disposed about the mica layer 90, the foam layer 92, the adhesive tape 94, the mica layer 96, and the aerogel layer 98. The housing 100 is a polymer-based spray transfer molded housing in this example, but other types of housings could be used in other examples.

A person having skill in this art and the benefit of this disclosure would be able to structurally distinguish a housing that is a spray transfer molded housing from a housing that is not a spray transfer molded housing. The housing 100 being a spray transfer molded housing thus structurally distinguishes the housing 100 from other housings that are not spray transfer molded housings.

In some examples, the spray transfer molded housing 100 is coated in a liquid resin, such as polyurethane at 75 to 85 percent aliphatic isocyanates (e.g., hexamethylene diisocyanate, isophorone diisocynate) and 10 to 20 percent polyester-based polyol or bio-polyols, such as 10 to 20 percent glycerol based/recinoleic acid based polyol. The liquid resin can include tertiary amines as a catalyst to increase reactivity along with a thermal insulating additive mixture of 0.2 to 0.5 percent by weight aerogel particles (particle size of 15 to 70 microns) along with 0.2 to 0.8 percent by weight glass micro spheres or sodium silicate powder. The diisocyanates can be kept in separate day tanks. In some examples, the iso cyanate is mixed with polyol mixture just before spray application on a substrate along with multiple layers to be spray transfer molded under low heat and compression after the spray us applied on a multilayer construction

The mica layers 90 and 96 can be layers of mica tape, for example.

The foam layer 92, in this example, is a ceramic foam. During operation of the traction battery pack 14, the battery cells 46 may expand occur along the cell stack axis A. The foam layer 92 within the spray transfer molded housing 100 can compress in response to expansion of the battery cells 46 to accommodate expansion of the battery cells 46 along the cell stack axis A. The foam layer 92 makes the first compressible pad 74 compressible.

The second compressible pad 78 is constructed similarly to the first compressible pad 74 but mirrored about the column portion 82 of the frame 70. The foam layer 92 within the second compressible pad 78 compresses in response to battery cells 46 expanding along the cell stack axis A like the foam layer 92 of the first compressible pad 74.

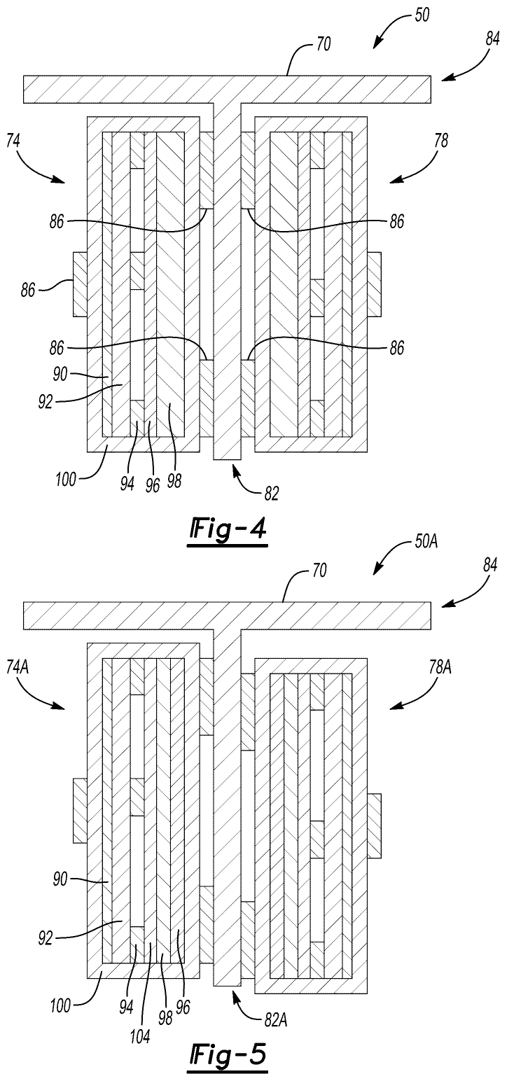

With reference now to FIG. 5, another exemplary divider assembly 50A includes the frame 70, a first compressible pad 74A, and second compressible pad 78A secured to opposing axially facing sides of the column portion 82 of a frame 70. The first compressible pad 74A and second compressible pad 78A differ from the first compressible pad 74 and the second compressible pad 78 of the divider assembly 50 in FIG. 4 as the first compressible pad 74A and the second compressible pad 78A each include a mesh sheet 104 within the housing 100A next to the aerogel layer 98 instead of the mica layer 96, which is repositioned closer to the frame 70 to sandwich the aerogel layer 98 between the mica layer 96 and the mesh sheet 104. The mesh sheet 104 can be a stainless steel mesh sheet, for example. The second compressible pad 78A is constructed similarly to the first compressible pad 74A, but mirrored about the column portion 82 of the frame 70.

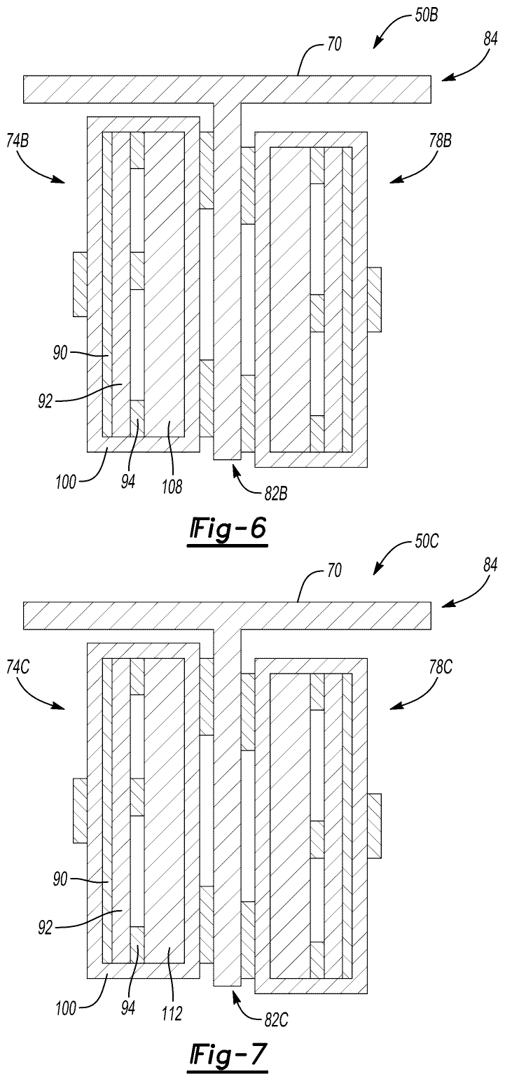

With reference now to FIG. 6, another exemplary divider assembly 50B includes a first compressible pad 74B, and a second compressible pad 78B secured to opposing axially facing sides of the column portion 82 of the frame 70. The example first compressible pad 74B and second compressible pad 78B differ from the first compressible pad 74 and the second compressible pad 78 of the divider assembly 50 due to, among other things, the mica layer 96 and aerogel layer 98 being replaced by a basalt layer 108. The second compressible pad 78B is constructed similarly to the first compressible pad 74A, but mirrored about the column portion 82.

Referring now to FIG. 7, yet another exemplary divider assembly 50C includes a first compressible pad 74C and a second compressible pad 78C secured to opposing axially facing sides of the column portion 82 of the frame 70. The first compressible pad 74C and the second compressible pad 78C differ from the first compressible pad 74B and the second compressible pad 78B in the embodiment of FIG. 6 in that the basalt layer 108 is replaced with a densified non-woven ceramic layer 112. The second compressible pad 78C is constructed similarly to the first compressible pad 74C, but mirrored about the column portion 82 of the frame 70.

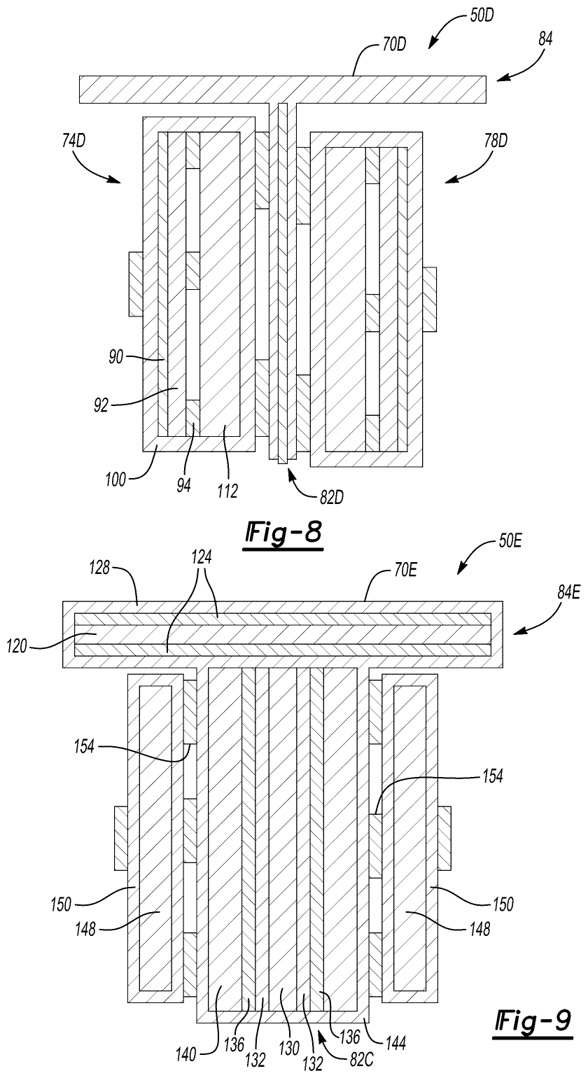

With reference now to FIG. 8, a divider assembly 50D according to yet another exemplary aspect of the present disclosure includes a first compressible pad 74D and a second compressible pad 78D constructed similarly to the first compressible pad 74C and the second compressible pad 78C of the FIG. 7 embodiment. The divider assembly 50D differs from the divider assembly 50C in that the frame 70D of the divider assembly 50D includes a column portion 82D having a stainless steel sheet 116 sandwiched between polymer based layers. The frame 70D can be used in place of the frame 70 shown in the embodiments of FIGS. 4 to 7.

Referring now to FIG. 9, yet another exemplary divider assembly 50E includes a frame 70E having a multi-layered platform portion 84E and a multi-layered column portion 82E. In the exemplary embodiment, the multi-layered platform portion 84E of the frame 70E includes a basalt mat layer 120 sandwiched between steel layers 124. The basalt mat layer 120 and the steel layers 124 are housed within a housing 128 that is a spray transfer molded housing.

The multi-layered column portion 82E of the frame 70E includes an aramid honeycomb layer 130 sandwiched between aerogel sheet layers 132, which are then sandwiched between steel mesh sheet layer 136. The aramid honeycomb layer 130, the aerogel sheet layers 132, and the steel mesh sheet layers 136 are then sandwiched between mica sheet layers 140 and housed within a housing 144. The housing 144 can be a spray transfer molded housing.

Attached to opposing axially facing sides of the multi-layered column portion 82E are aerogel sheets 148 housed within a housing 150, which can be a spray transfer molded housing. The aerogel sheet layers 132 and associated housing 150 can be secured to opposing axially facing sides of the column portion 82E using mica tape 154.

The column portions 82, 82D, 82E, for the frames 70-70E can be constructed separately from the respective platform portions 84, 84D, 84E, and then joined to the respective platform portions 84, 84D, 84E during, for example, an in molding process.

Features of the disclosed examples include divider assemblies for a cell stack of a battery pack that include compressible layers to accommodate expansion of battery cells of the cell stack along the axis A.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
a cell stack within an interior of an enclosure, the cell stack including a plurality of battery cells and a divider assembly disposed along a cell stack axis, the divider assembly arranged between a first battery cell and a second battery cell of the plurality of battery cells, the divider assembly including a compressible pad that includes a housing disposed about a foam.

2. The traction battery pack assembly of claim 1, wherein the foam is a ceramic foam.

3. The traction battery pack assembly of claim 2, wherein the housing is a spray transfer molded housing.

4. The traction battery pack assembly of claim 1, wherein the divider assembly further includes a frame having a T-shaped cross-sectional profile.

5. The traction battery pack assembly of claim 4, wherein the frame is a pultruded frame.

6. The traction battery pack assembly of claim 4, wherein the frame is an extruded frame.

7. The traction battery pack assembly of claim 1, wherein the divider assembly includes a polymer-based frame having a column portion sandwiched between the first battery cell and the second battery cell, and a platform portion disposed outside the plurality of battery cells relative to the cell stack axis, the compressible pad a first compressible pad on a first side of the column portion, the divider assembly further including a second compressible pad on an opposite, second side of the column portion.

8. The traction battery pack assembly of claim 7, wherein the platform portion is configured to interface with an enclosure cover or an intermediate structure.

9. The traction battery pack assembly of claim 7, wherein the first compressible pad and the second compressible pad are secured to the column portion with an adhesive tape.

10. The traction battery pack assembly of claim 1, wherein the compressible pad further includes mica layers sandwiching the foam within the housing.

11. The traction battery pack assembly of claim 10, wherein the compressible pad further includes an aerogel layer within the housing.

12. The traction battery pack assembly of claim 1, wherein the compressible pad further includes a mesh layer within the housing.

13. The traction battery pack assembly of claim 1, wherein the compressible pad further includes a basalt layer within the housing.

14. The traction battery pack assembly of claim 1, wherein the compressible pad further includes a densified, non-woven ceramic layer within the housing.

15. The traction battery pack assembly of claim 1, wherein the divider assembly includes a polymer-based frame having a column portion sandwiched between the first battery cell and the second battery cell, and a platform portion disposed outside the plurality of battery cells relative to the cell stack axis, the compressible pad a first compressible pad on a first side of the column portion, the divider assembly further including a second compressible pad on an opposite, second side of the column portion, wherein the column portion includes a metal or metal alloy layer.

16. The traction battery pack assembly of claim 15, wherein the metal or metal alloy layer is stainless steel.

17. The traction battery pack assembly of claim 1, wherein the divider assembly includes a T-shaped frame having a column portion sandwiched between the first battery cell and the second battery cell, and a platform portion disposed outside the plurality of battery cells relative to the cell stack axis, the compressible pad a first compressible pad on a first side of the column portion, the divider assembly further including a second compressible pad on an opposite, second side of the column portion.

18. The traction battery pack assembly of claim 17, wherein the column portion includes a column housing disposed about a multi-layered column structure, wherein the platform portion includes a platform housing disposed about a multi-layered platform structure.

19. The traction battery pack assembly of claim 18, wherein the multi-layered column structure includes at least one aramid honeycomb layer, at least one aerogel layer, at least one metallic mesh layer, and at least one mica layer.

20. The traction battery pack assembly of claim 18, wherein the multi-layered platform structure includes at least one aramid honeycomb layer sandwiched between a pair of metallic layers.
